(19) United States
(12) Patent Application Publication
(10) Pub. No.: US 2004/0196548 A1
(43) Pub. Date: Oct. 7, 2004

(54) Optical viewing device for inwardly or outwardly reflecting image data provided with additional diaphragms

(76) Inventors: Jurgen Mannss, Oberdiessbach (CH); Roger Spinks, Berneck (CH); Benno Moser, Berneck (CH)

Correspondence Address: FOLEY AND LARDNER, SUITE 500, 3000 K STREET NW, WASHINGTON, DC, 20007, US

(21) Appl. No.: 10/474,710

(22) PCT Filed: Apr. 4, 2002
(86) PCT No.: PCT/EP02/03749

(30) Foreign Application Priority Data
Apr. 12, 2001 (DE) 101 18 702.5

(51) Int. Cl. G02B 21/06

(52) U.S. Cl. 359/388; 359/368

(57) ABSTRACT

The invention relates to an optical observation instrument, for example a (stereo) operation microscope, having an additional shutter (4) in a main beam path (2b), arranged between an output-reflection beam splitter (3) and an observer eyepiece (5), for respectively connecting and disconnecting the observer (8a), without affecting the output-reflected signal.

As a special refinement, a special shutter design is described, which makes it possible to respectively connect and disconnect the two main beam paths (2a, 2b) and involves an override function (quick reset) for opening both beam paths.

The invention relates to an optical observation instrument, for example a (stereo) operation microscope, having an additional shutter in a main beam path for respectively connecting and disconnecting the observer, without affecting the output-reflected signal.

Extraction and insertion by means of input-and output reflection devices is being used increasingly in many fields, since information reflected into the observation field of optical systems significantly increases the amount of information available to the user. Output reflection of images of the object is used either to supply object information to a further observer, for example an operation assistant, or to deliver it to an image processing unit, for example a video system. The input and output reflection is typically curried out by means of beam spatters in the main beam path.

In order to provide the user with the opportunity to decide whether the observation field and/or only the input-reflected image is to be viewed, shutters are used to include and exclude the object image. In currently known devices, they are positioned in the respective main beam path between the lens and the corresponding beam splitter.

The shutters are designed so that three observation states can be achieved (considering one beam path in each case):

View of object

View of object together with the input-reflected image

Only the input-reflected image

Furthermore, with currently known shutters it is not reliably possible, as and when required, for the basic state to be displayed, i.e. the full object image appears in both beam paths, by means of manual action, in a simple way and within a very short time.

The inventor has recognised that known systems are disadvantageous in terms of the following points;

a) When closing the shutter in the main beam path, in which the output reflection is extracted, a possible co-observer and/or an image processing unit, e.g. a video system, is shut out since dosing the shutter also isolates the output reflection system from its image source (object).

b) Coupling of the output and input reflection, for example insertion of the output-coupled image, is not possible in all of the three said states.

c) The shutters currently used in a stereo microscope have no facility for letting both of the surgeon's eyes see the object within a very short time, for example in an emergency situation (for instance when the shutter control fails completely).

d) Current input reflection devices have only an insufficient facility for changing between original and/or video-assisted object representations and/or computer-generated input reflections.

It is therefore an object of the invention to provide an instrument for input and output reflection of image date which avoids the said disadvantages, irrespective of which combinations of input and output reflections, or object images, are used. Furthermore, the design features of the shutters that are used are to be simplified, and it should be possible to connect the object image in both beam paths within a very short time.

These objects are alternatively achieved by

i) the use of a shutter in the main beam path between the output-reflection beam splitter and the observer eyepiece and/or by a refinement or alternatives that can be used independently thereof.

ii) the use of a shutter in the output-reflected beam path and/or by a refinement or alternatives that can be used independently thereof.

iii) the facility for switching between an electronically generated input-reflection signal and any desired video signal and/or by a refinement or alternatives that can be used independently thereof.

iv) the use of a shutter design with an override function.

The use of shutters in the main beam path between the beam splitter and the observer eyepiece and/or in the output-reflected beam path is novel per se and can be used according to the invention, in particular in the scope of the various novel possibilities, to generate combinations of an object image, output reflection and input reflection, irrespective of the other said possibilities.

The use of two separate input-coupling sources (computer-generated signal/video-assisted object image), which can be switched over or used in combination, is novel per se and can be used according to the invention, in particular in the scope of the additional information in the observers field of view, irrespective of the other said possibilities.

The use of a shutter with an override function (quick reset) is novel per se and can be used according to the invention, in particular in the scope of the particularly fast and straightforward resetting to the state with an unimpeded view of the object, irrespective of the other said possibilities.

With the various inventive measures, the following improvements can be achieved in subsequent steps:

By using a shutter in the main beam path between the output-reflection beam splitter and the observer eyepiece, the output-reflected signal is not affected, irrespective of whether or not the observer, for example a surgeon, is observing the object directly.

By using a shutter in the output-reflection beam path, the object image for the observer is not affected, irrespective of whether the output-reflected beam path is disconnected or connected.

In the case of an input-reflection beam path for the reflection of information into the output-reflection beam path, an additional observer, for example an assistant, can be supplied with further image information.

Since all shutters can selectively be switched separately or at least partially with one another, any desired combinations of an object image, output reflection and input reflection can be generated.

The possibility of changing between, or combining, an electronically generated input-reflection signal and any desired video signal, provides great flexibility for the input-reflected information.

By using a shutter design according to the invention in the main beam paths, the design complexity is reduced.

By using an override function, a quick reset of the respective shutter in the main beam paths is possible, so that an observer can immediately obtain an unimpeded view of the object, irrespective of the currently selected shutter setting.

Although the present text refers to a surgeon and an operation microscope, the invention is not restricted thereto, but rather is available to other users of optical devices with input and output reflections and/or with shutters for the disconnection and connection of individual beam paths (e.g. projectors with input-reflected additional information, video and photographic cameras, especially binocular applications). The patent claims are accordingly configured with the wide scope.

The list of references, as well as FIG. 1, FIG. 2 and. FIG. 3, are an integral part of the disclosure of this application, together with the subject-matter described and protected in the claims.

### DESCRIPTION OF THE FIGURES

The figures will be described in brief and comprehensively. The same reference numbers denote the same components, and reference numbers with different indices indicate functionally equivalent components.

FIG. 1 symbolic overall view of an optical observation instrument, for example a stereo operation microscope, with input- and output-reflection beam paths;

FIG. 2 schematic plan-view representation of a shutter with a quick-reset function; and

FIG. 3 schematic side view of the shutter represented in FIG. 2.

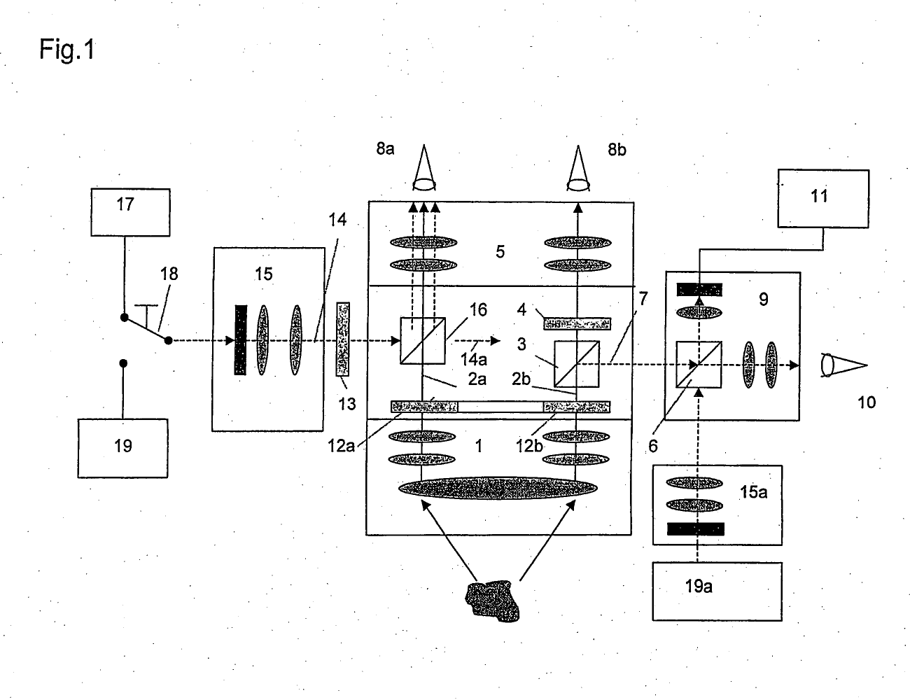

FIG. 1 symbolically shows the overall structure of an optical observation instrument having a main lens 1, a left and right beam path 2a, 2b, a shutter 12a, 12b, an output-reflection beam splitter 3 in the right beam path 2b and an additional shutter 4 according to the invention in the main beam path 2b, arranged in the right beam path 2b between the output-reflection beam splitter 3 and the observer eyepiece 5. The output-reflected beam path 7, a beam splitter 6 in the output-reflected beam path, a connection 9 to an additional observer 10, or an electronic observation unit 11, for example a video system, are furthermore represented. Also represented are the input-reflection device 15 needed for the input reflection, an additional video signal 17 according to the invention, an electronically generated input-reflection signal 19, a changeover switch 18, a shutter in the input-reflected beam path 13 and an input-reflection beam splitter 16 in the left main beam path 2a. The symbolic representations do not imply any limitation. In particular, output- and input-reflection beam paths 7, 14 of the indicated type may be used for the indicated purpose in the left as well as the right main beam path 2a, 2b.

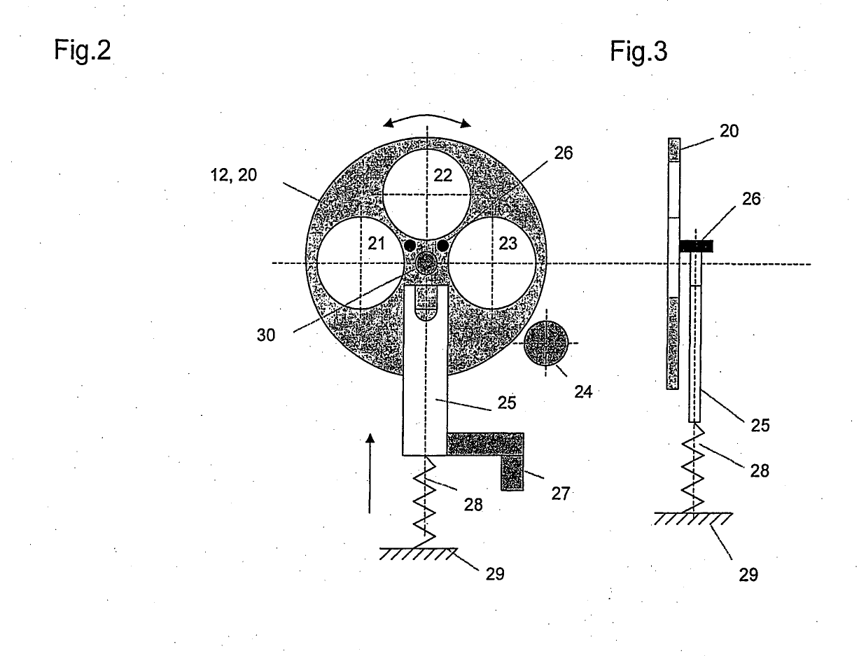

FIG. 2 shows a shutter design 12 according to the invention with an override function (quick reset) in plan view, based on a shutter disc 20 that can be rotated about an axle 30 and has three holes 21, 22, 23, and a gear 24, for example a pinion, which is connected to a motor for operating the shutter disc 20. Also represented are the lever 25 for the override function, with a push button 27, the resetting spring 28 and the housing 29. Filter discs may also be fitted in the holes 21, 22, 23, if required, so that this structure can also be used as an override structure for filter wheels.

FIG. 3 shows a side view of the shutter design represented in FIG. 2. Also depicted are elements required according to the invention for the override function, the displaceable lever 25 and the cams 28 arranged at a 90 degree angle.

### Function

The light coming from the object in the right main beam path 2b is conducted via a main lens 1, a specially designed shutter 12, an output-reflection beam splitter 3 and an additional shutter 4 according to the invention, through the observer eyepiece 5 to the observer 8b. The output-reflected beam path 7 is deflected via a beam splitter 8 onto the connection 9 to an additional observer 10, for example an assistant, and/or onto an electronic observation unit 11, for example a video system. By the special arrangement of the shutter 4 in the main beam path 2b between the beam splitter 3 and the observer eyepiece 5, it is possible, according to the invention, to connect or disconnect the observer 8b without affecting the output-reflected signal 7.

The input-reflected signal 14 is generated according to the invention selectively and/or via the switch 18, for example a prism, by any desired video signal 17, for example the object image, or an electronic input-reflection signal 19. It is reflected via an input-reflection device 15 and a shutter 13, by means of an input-reflection beam splitter 16, into the left main beam path 2a. This invention can also be used irrespective of the other said possibilities.

The shutter 12 specially designed according to the invention in the main beam paths 2a, 2b permits, on the one hand, a simple mechanical design and, on the other hand, an override function (quick reset). By means of this function, the observer 8 can see the entire object image within a very short time, when required, since the shutter is brought mechanically into the reset position by pressing a button. This invention can also be used irrespective of the other said possibilities.

The shutter disc 20 which can be rotated according to the invention doses the left beam path 2a or the right beam path 2b, depending on the angle of rotation. It is driven via a gear 24, for example via a pinion, with an electrically and/or electronically operated electric motor.

By pressing the button 27 of the displaceable lever 25, according to the invention the shutter disc 20 is turned within a very short time into the represented starting position, via the two cams 26 fitted in a 90 degree position, so that both beam paths 2a, 2b are opened.

### List of References

1 Main lens

2 Left/right main beam path

3 Output-reflection beam splitter in the main beam path

4 Shutter in the main beam path

5 Observer eyepiece

6 Beam splitter in the output-reflected beam path

7 Output-reflected beam path/output-reflected signal

8 Main observer

9 Connection in the output-reflected beam path

10 Additional observer, for example assistant

11 Electronic observation unit, for example video system

12 Shutter in the main beam path

13 Shutter in the input-reflected beam path

14 Input-reflected beam path/stereo signal for both beam paths

15 Input-reflection device main observer

15a Input-reflection device additional observer

16 Input-reflection beam splitter in the main beam path

17 Video signal

18 Switch electronically generated/video signal

19 Electronically generated input-reflection signal for main observer

19a Electronically generated input-reflection signal for additional observer

20 Rotatable shutter disc

21 Hole

22 Hole

23 Hole

24 Gear

25 Lever for override function

26 Cam for override function

27 Push button

28 Tension spring

29 Housing

30 Rotation axle

1. Optical observation instrument, in particular stereo operation microscope, having a main lens (1), a left and a right main beam path (2a, 2b) and having at least one output-reflection beam path (7) and having at least one output-reflection beam splitter (3) in the main beam path (2b) for the output reflection of the object image, and an observer eyepiece (5), characterised in that a selectively controllable shutter (4) is arranged in the main beam path (2b) between the beam splitter (3) and the observer eyepiece (5).

2. Microscope according to claim 1, characterised in that a selectively controllable input-reflection shutter (13) is additionally arranged in the input-reflected beam path (14).

3. Microscope according to claim 1, characterised in that a selectively controllable shutter (12) is arranged in at least one of the main beam paths (2a, 2b) between the main lens (1) and the beam splitters (3, 16).

4. Microscope according to one of the preceding claims, characterised in that all shutters (4, 12, 13) can selectively be switched separately or at least partially with one another.

5. Microscope according to claim 1, characterized in that an input-reflection device (15) for displaying a video image is arranged between the shutter (12) and the eyepiece (5).

6. Microscope according to one of the preceding claims, characterised in that the input-reflected beam path (14) can be disconnected and connected independently of the observer (8a).

7. Microscope according to one of the preceding claims, characterised in that at least one of the shutters (4, 12, 13) can be remote-controlled manually or using a motor.

8. Microscope according to one of the preceding claims, characterised in that a connection (9) for a further observer (10) can be arranged in the output-reflected beam path (7).

9. Microscope according to one of the preceding claims, characterised in that a connection (9) for an electronic observation unit (11), for example a video recording system, can be arranged in the output-reflected beam path (7).

10. Microscope according to one of the preceding claims, characterised in that an input-reflection device (15) having an input-reflection beam splitter (16) can be arranged in the second main beam path (2a).

11. Microscope according to one of the preceding claims, characterised in that an input-reflection device (15a) having an input-reflection beam splitter (16) can be arranged in the output-reflected beam path (7).

12. Microscope according to one of the preceding claims, characterised in that an electronically generated input-reflection signal (19) or a video signal (17), for example the object image, can be reflected in selectively via a switch (18), for example a prism.

13. Microscope according to one of the preceding claims, characterised in that the input reflection can be reflected into both main beam paths (2a, 2b) as a stereo-image signal (14, 14a).

14. Microscope according to one of the preceding claims, characterised in that the switch (16) can be operated electronically and/or manually,

15. Microscope according to one of the preceding claims, characterised in that at least one of the shutters (4, 12, 13) is designed as a rotatable shutter disc (20) having, in particular, three holes (21, 22, 23) for opening and closing the left (2a) or right (2b) beam path, respectively.

16. Microscope according to one of the preceding claims, characterised in that at least the shutter disc (20) can be operated using an electric motor.

17. Microscope according to one of the preceding claims, characterised in that at least one of the shutters (4, 12, 13) can be operated electronically or manually.

18. Microscope according to one of the preceding claims, characterised in that a mechanical override function (quick reset) is provided.

19. Microscope according to one of the preceding claims, characterised in that the shutter (12) can be reset by means of a lever (25), which operates the shutter disc (20) via two cams (26), from any position to the starting position by pressing a button (27) (override function, quick reset).

20. Microscope according to one of the preceding claims, characterised in that the lever (25) can be actuated manually or electromechanically via a button (27).
